(19) United States
(12) Patent Application Publication
(10) Pub. No.: US 2012/0081581 A1
(43) Pub. Date: Apr. 5, 2012

(54) IMAGE CAPTURING APPARATUS, LIGHT-EMITTING DEVICE AND IMAGE CAPTURING SYSTEM

(75) Inventor: Yoshiro Ichihara, Yokohama-shi (JP)

(73) Assignee: CANON KABUSHIKI KAISHA, Tokyo (JP)

(21) Appl. No.: 13/230,286

(22) Filed: Sep. 12, 2011

(30) Foreign Application Priority Data
Oct. 4, 2010 (JP) 2010-225167

(51) Int. Cl. H04N 9/68

(52) U.S. Cl. 348/238; 348/E09.053

(57) ABSTRACT

The present invention provides an image capturing apparatus, which is configured to capture an image using a light-emitting device, including a photometry unit configured to perform photometry on a plurality of regions, a calculation unit configured to calculate an emission amount of the light-emitting device based on photometry results of the photometry unit, and a display unit configured to display information associated with differences between proper emission amounts respectively for the plurality of regions and the emission amount calculated by the calculation unit.

### BACKGROUND OF THE INVENTION

1. Field of the Invention

The present invention relates to an image capturing apparatus, light-emitting device, and image capturing system.

2. Description of the Related Art

In an image capturing apparatus such as a digital camera, a technique for executing light adjustment control by setting a light adjustment area based on information (accessory information) of a lens, strobe, and the like, which are attached to the image capturing apparatus is known (see Japanese Patent Laid-Open No. 2007-212866).

However, even when the light adjustment area is set based on the accessory information like in the related art, a proper exposure value (light amount) cannot often be set for a point (region) intended by the user (photographer) in a composition including a plurality of objects. Such problem is also posed when the strobe is controlled to emit preliminary light, reflected light from an object is received by a light-receiving unit of the camera, and an emission amount of the strobe at an actual image capturing timing is calculated from the light-receiving result.

In this case, a composition will be examined below in which trees TR1 and TR2 exist on the left front side and right front side of an image capturing region (image), and a house HO exists at the central back side of the image capturing region, as shown in FIG. 14A. For example, as shown in FIG. 14B, when it is judged based on the light-receiving result of reflected light from an object by emitting preliminary light that a proper exposure value is set for the trees TR1 and TR2, and an image is captured, if a point intended by the user to set a proper exposure value corresponds to the trees TR1 and TR2, no problem is posed. However, if the point intended by the user to set a proper exposure value does not correspond to the trees TR1 and TR2 but to the house HO, an exposure value has to be corrected to set a proper exposure value on the house HO, and an image has to be captured again, as shown in FIG. 14C. Note that the house HO is underexposed compared to the proper exposure value in FIG. 14B, and the trees TR1 and TR2 are overexposed compared to the proper exposure value in FIG. 14C.

### SUMMARY OF THE INVENTION

The present invention provides a technique advantageous for setting light amounts on regions obtained by dividing an image capturing region to be proper light amounts.

According to one aspect of the present invention, there is provided an image capturing apparatus, which is configured to capture an image using a light-emitting device, including a photometry unit configured to perform photometry on a plurality of regions, a calculation unit configured to calculate an emission amount of the light-emitting device based on photometry results of the photometry unit, and a display unit configured to display information associated with differences between proper emission amounts respectively for the plurality of regions and the emission amount calculated by the calculation unit.

Further aspects of the present invention will become apparent from the following description of exemplary embodiments with reference to the attached drawings.

### BRIEF DESCRIPTION OF THE DRAWINGS

FIG. 1 is a schematic view showing the arrangement of an image capturing system according to an embodiment of the present invention.

FIG. 2 is a view showing a division example of an image capturing region of an image sensor in the image capturing system shown in FIG. 1.

FIG. 3 is a flowchart for explaining the operation of the image capturing system shown in FIG. 1.

FIG. 4 is a flowchart for explaining the operation of the image capturing system shown in FIG. 1.

FIG. 5 is a flowchart for explaining the operation of the image capturing system shown in FIG. 1.

FIG. 6 is a flowchart for explaining the operation of the image capturing system shown in FIG. 1.

FIGS. 7A and 7B show display examples of strobe information on a display unit of a strobe device in the image capturing system shown in FIG. 1.

FIG. 8 is a flowchart for explaining the operation of the image capturing system shown in FIG. 1.

FIGS. 9A to 9C show display examples on a display unit of an image capturing apparatus in the image capturing system shown in FIG. 1.

FIG. 10 is a flowchart for explaining the operation of the image capturing system shown in FIG. 1.

FIG. 11 is a flowchart for explaining the operation of the image capturing system shown in FIG. 1.

FIGS. 12A and 12B are views for practically explaining the operation of the image capturing system shown in FIG. 1.

FIG. 13 is a view for explaining a case in which two or more regions are selected as regions to be set to have a proper luminance value from a plurality of regions obtained by dividing the image capturing region of the image sensor.

FIGS. 14A to 14C are views for explaining problems in the related art.

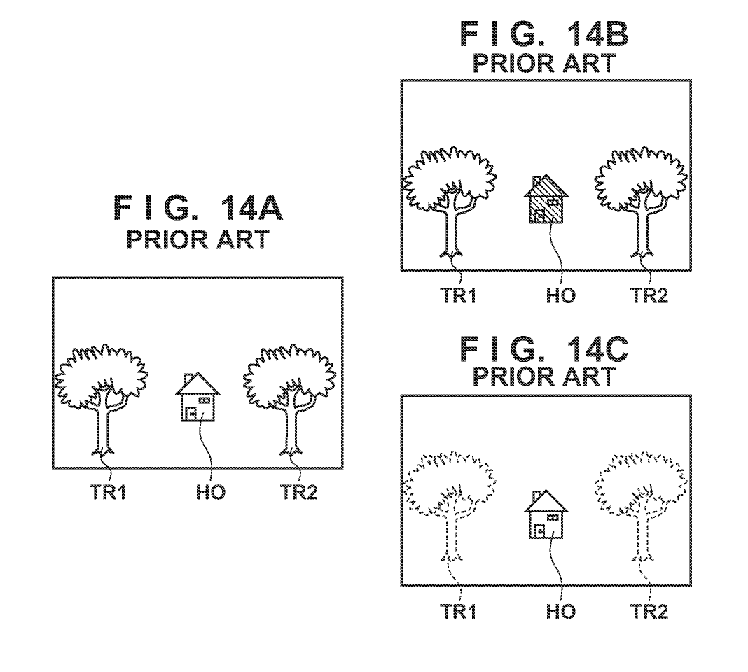

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

### First Embodiment

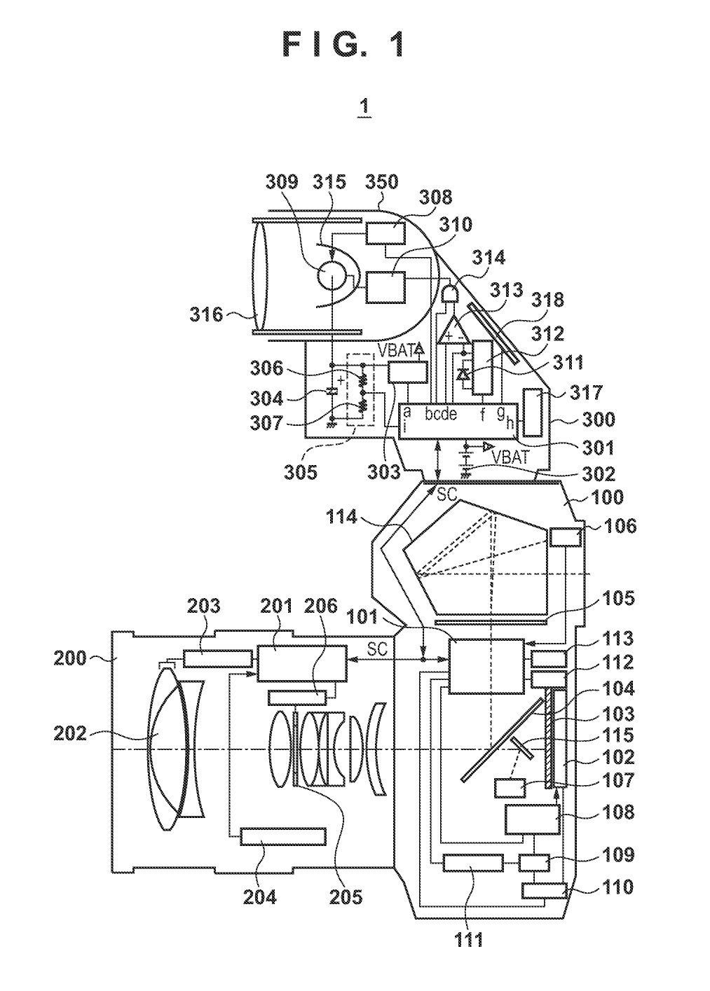

FIG. 1 is a schematic view showing the arrangement of an image capturing system 1 according to an embodiment of the present invention. The image capturing system 1 includes an image capturing apparatus 100, and a lens 200 and strobe device (light-emitting device) 300, which are mounted on the image capturing apparatus 100.

The image capturing apparatus 100 includes a main controller 101, image sensor 102, shutter 103, main mirror 104, focusing plate 105, detector 106, focus detector 107, gain setting unit 108, A/D converter 109, and timing generator (TG) 110. Also, the image capturing apparatus 100 includes an image processor 111, operation unit 112, display unit 113, pentagonal prism 114, and sub mirror 115.

The main controller 101 controls the overall operation of the image capturing apparatus 100 (that is, the respective units of the image capturing apparatus 100). The main controller 101 is configured by, for example, a one-chip IC circuit with a built-in microcomputer, which includes a CPU, ROM, RAM, input/output (I/O) control circuit, multiplexer, timer circuit, EEPROM, A/D converter, D/A converter, and the like. Note that the EEPROM is a ROM which can electrically write and erase data. The main controller 101 executes programs stored in the ROM, and executes processes of respective embodiments in cooperation with a lens controller 201 and strobe controller 301.

The image sensor 102 is configured by a CCD sensor or CMOS sensor including an infrared cut filter, low-pass filter, and the like. On the image sensor 102 (on an image capturing region thereof), an image of an object is formed at an image capturing timing. The shutter 103 shields the image sensor 102 at a non-image capturing timing (that is, it prevents light coming from the lens 200 from entering the image sensor 102), and guides light coming from the lens 200 to the image sensor 102 at an image capturing timing.

The main mirror 104 is configured by a half mirror. The main mirror 104 reflects some light rays coming from the lens 200 to form an image on the focusing plate 105 at a non-image capturing timing. The focusing plate 105 constitutes a part of an optical viewfinder (not shown).

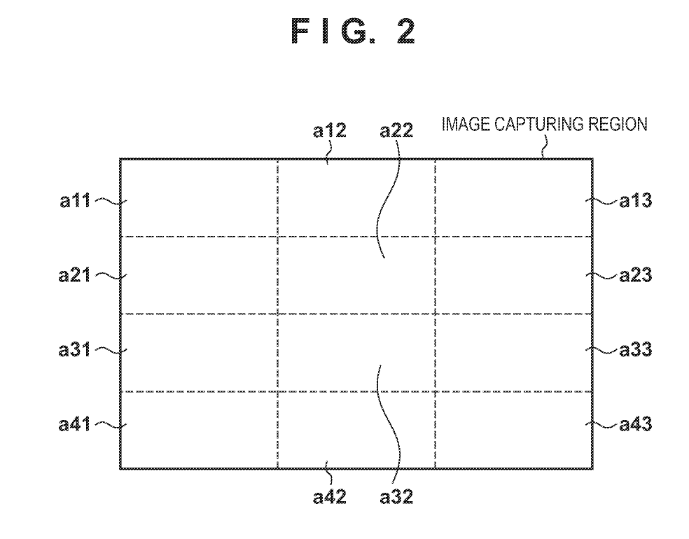

The detector 106 is configured by a photometry circuit including a photometry sensor. The detector 106 performs photometry on an image capturing range of an object, that is, a plurality of regions obtained by dividing an image capturing region of the image sensor 102 (it detects light amounts of light rays respectively incident on the plurality of regions). In this embodiment, as shown in FIG. 2, the detector 106 performs photometry respectively on regions a11, a12, a13, a21, a22, a23, a31, a32, a33, a41, a42, and a43 obtained by dividing the image capturing region of the image sensor 102 into 12 regions. Note that the detector 106 receives, via the pentagonal prism 114, an image of an object formed on the focusing plate 105.

The focus detector 107 is configured by a focus detection circuit including a focus detection sensor. The focus detector 107 has a plurality of focus detection points, and is configured to include the focus detection points at positions corresponding to the plurality of regions obtained by dividing the image capturing region of the image sensor 102.

The gain setting unit 108 sets a gain of an image signal generated by the image sensor 102 according to an image capturing condition, charging voltage condition, inputs of the user (photographer), and the like. The A/D converter 109 converts an analog image signal from the image sensor 102 into a digital image signal. The TG 110 controls to synchronize an input timing of the image signal from the image sensor 102 with a conversion timing of the A/D converter 109. The image processor 111 applies image processes specified by various image processing parameters to the digital image signal converted by the A/D converter 109.

The operation unit 112 includes various buttons, a dial, and the like, which accept operations (instructions and settings) from the user. The operation unit 112 includes, for example, a shutter button required to instruct to capture an image of an object, a preliminary emission button required to instruct to perform preliminary emission prior to image capturing (actual image capturing) of an object, and a selection button required to select one or two or more regions from the plurality of regions obtained by dividing the image capturing region of the image sensor 102.

The display unit 113 displays an image corresponding to an image signal output from the image processor 111, and a state of the image capturing apparatus 100 (an image capturing mode, image capturing information, and the like set in the image capturing apparatus 100). The display unit 113 has, for example, a display mode of a liquid crystal TFT system, and can display numerals, characters, lines, and the like at desired positions on a display screen. Note that when a touch panel is arranged on the display unit 113, for example, the user can select, using the touch panel, one or two or more regions from the plurality of regions obtained by dividing the image capturing region of the image sensor 102, and the display unit 113 can serve as a part of the operation unit 112.

The pentagonal prism 114 guides an image of an object formed on the focusing plate 105 to the detector 106 and an optical viewfinder (not shown). The sub mirror 115 reflects light transmitted through the main mirror 104, and guides it to the focus detector 107.

A communication line SC serves as a communication interface between the image capturing apparatus 100 and lens 200, and that between the image capturing apparatus 100 and strobe device 300. The communication line SC allows to exchange data and to transfer commands between the lens 200 and strobe device 300 to have, for example, the main controller 101 as a host.

The lens 200 includes the lens controller 201, a lens group 202, a lens driver 203, an encoder 204, a stop 205, and a stop driver 206.

The lens controller 201 controls the overall operation of the lens 200 (that is, respective units of the lens 200). The lens controller 201 is configured by, for example, a one-chip IC circuit with a built-in microcomputer, which includes a CPU, ROM, RAM, I/O control circuit, multiplexer, timer circuit, EEPROM, A/D converter, D/A converter, and the like. The lens controller 201 executes programs stored in the ROM, and execute processes of respective embodiments in cooperation with the main controller 101 and strobe controller 301.

The lens group 202 is configured by a plurality of lenses (optical system). The lens driver 203 drives a focus adjustment lens included in the lens group 202. The encoder 204 detects a position of the focus adjustment lens when the focus adjustment lens is driven. The main controller 101 calculates (computes) a driving amount of the focus adjustment lens based on the detection result of the focus detector 107 of the image capturing apparatus 100, and sends it to the lens controller 201. The lens controller 201 drives the focus adjustment lens to an in-focus position via the lens driver 203 based on that driving amount while controlling the encoder 204 to detect the position of the focus adjustment lens. The stop 205 is controlled by the lens controller 201 via the stop driver 206 which drives the stop 205. Note that the focal length of the lens group 202 may be a single focus or variable (that is, a zoom lens may be included).

The strobe device 300 includes the strobe controller 301, a battery 302, a booster circuit 303, a main capacitor 304, a voltage detector 305, resistors 306 and 307, and a trigger circuit 308. Also, the strobe device 300 includes a discharge tube 309, emission controller 310, photodiode 311, integrating circuit 312, comparator 313, AND gate 314, reflector 315, optical system 316, input unit 317, and display unit 318.

The strobe controller 301 controls the overall operation of the strobe device 300 (that is, respective units of the strobe device 300). The strobe controller 301 is configured by, for example, a one-chip IC circuit with a built-in microcomputer, which includes a CPU, ROM, RAM, I/O control circuit, multiplexer, timer circuit, EEPROM, A/D converter, D/A converter, and the like. The strobe controller 301 executes programs stored in the ROM, and executes processes of respective embodiments in cooperation with the main controller 101 and lens controller 201.

The battery 302 serves as a power supply (VBAT) of the strobe device 300, and is connected to the strobe controller 301 and booster circuit 303. The booster circuit 303 is a circuit used to boost a voltage of the battery 302 to several hundred V. The booster circuit 303 is connected to an a terminal of the strobe controller 301, and controls the main capacitor 304 to accumulate an energy (voltage) required for the discharge tube 309 to emit light.

The main capacitor 304 is configured by a high-voltage capacitor. In this embodiment, the main capacitor 304 charges up to 330 V, and discharges when the discharge tube 309 emits light. The voltage detector 305 is connected to the two terminals of the main capacitor 304, and detects the voltage of the main capacitor 304. The voltage of the main capacitor 304 (that is, an energy accumulated on the main capacitor 304) is voltage-divided by the resistors 306 and 307. The voltage, which is voltage-divided by the resistors 306 and 307, is input to an A/D converter terminal via an i terminal of the strobe controller 301. Note that such information (the voltage of the main capacitor 304) is also sent from the strobe controller 301 to the main controller 101 via the communication line SC.

The trigger circuit 308 is connected to a b terminal of the strobe controller 301, and outputs a trigger signal pulse (pulse voltage) when the discharge tube 309 emits light. The discharge tube 309 emits light by exciting the energy charged on the main capacitor 304 by a pulse voltage of several kV applied from the trigger circuit 308, and irradiates an object with that light. The emission controller 310 controls to start and stop light emission of the discharge tube 309 in cooperation with the trigger circuit 308.

The photodiode 311 is a sensor used to detect an emission amount of the discharge tube 309, and receives light from the discharge tube 309 directly or via, for example, a glass fiber. The integrating circuit 312 is a circuit which integrates light received by the photodiode 311, that is, a light-receiving current. The integrating circuit 312 is connected to an f terminal of the strobe controller 301, and receives an integration start signal from the strobe controller 301. An output from the integrating circuit 312 is input to the A/D converter terminal via an inverting input terminal of the comparator 313 and an e terminal of the strobe controller 301.

A non-inverting input terminal of the comparator 313 is connected to a D/A converter output terminal via a d terminal of the strobe controller 301. An output terminal of the comparator 313 is connected to one input terminal of the AND gate 314. The other input terminal of the AND gate 314 is connected to a c terminal of the strobe controller 301. An output of the AND gate 314 is input to the emission controller 310.

The reflector 315 reflects light from the discharge tube 309. The optical system 316 is configured by a panel and the like, and specifies an irradiation angle of the strobe device 300. Note that the irradiation angle of the strobe device 300 may be variable. In this case, the irradiation angle is changed by changing the relative position between the discharge tube 309 and optical system 316. The input unit 317 is connected to an h terminal of the strobe controller 301, and accepts inputs from the user. The input unit 317 includes, for example, switches arranged on the side surface of the strobe device 300, and allows the user to manually input strobe information. Also, the input unit 317 includes, for example, a selection button used to select one or two or more regions from the plurality of regions obtained by dividing the image capturing region of the image sensor 102 in this embodiment.

The display unit 318 is connected to a g terminal of the strobe controller 301, and displays a state of the strobe device 300. The display unit 318 has, for example, a display mode of a liquid crystal dot matrix system, and can display numerals, characters, lines, and the like at desired positions on a display screen. When a touch panel is arranged on the display unit 318, for example, the user can select, using the touch panel, one or two or more regions from the plurality of regions obtained by dividing the image capturing region of the image sensor 102.

Practical operations of the image capturing system 1 will be described below. The image capturing system 1 starts its operation when a power switch of the image capturing apparatus 100 is turned on, and the main controller 101 is ready to communicate with the lens 200 (lens controller 201) and the strobe device 300 (strobe controller 301). Assume that the main controller 101 systematically controls the operation of the image capturing system 1 in this embodiment.

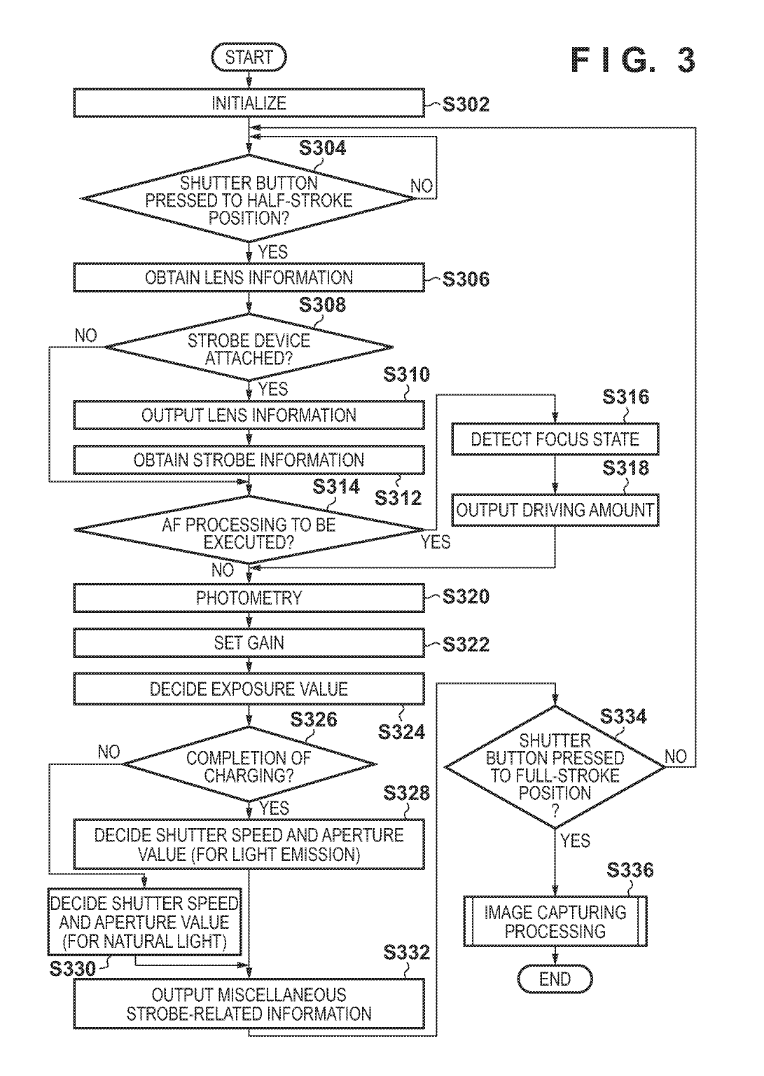

An operation especially when the user presses the shutter button to its half-stroke position of those of the image capturing system 1 will be described below with reference to FIG. 3.

In step S302, the main controller 101 initializes its memories and ports. Also, the main controller 101 loads statuses of various buttons of the operation unit 112 and information set on the operation unit 112, and sets an image capturing mode such as a shutter speed and aperture value.

In step S304, the main controller 101 determines whether or not the user presses the shutter button to its half-stroke position. If the user does not press the shutter button to its half-stroke position, the main controller 101 waits until the user presses the shutter button to its half-stroke position (that is, it repeats step S304). On the other hand, if the user presses the shutter button to its half-stroke position, the process advances to step S306. Note that when the user presses the shutter button to its half-stroke position, image capturing preparation processing (for example, automatic focus control (AF) processing) is generally started in the image capturing apparatus.

In step S306, the main controller 101 communicates with the lens 200 (lens controller 201) via the communication line SC to obtain lens information including focal length information of the lens 200 and information required for focus detection and photometry from the lens 200.

In step S308, the main controller 101 determines whether or not the strobe device 300 is attached to the image capturing apparatus 100. If the strobe device 300 is attached to the image capturing apparatus 100, the process advances to step S310. On the other hand, if the strobe device 300 is not attached to the image capturing apparatus 100, the process jumps to step S314.

In step S310, the main controller 101 communicates with the strobe device 300 (strobe controller 301) via the communication line SC to output the lens information obtained in step S306 (especially, the focal length information of the lens 200) to the strobe device 300. Note that the strobe controller 301 specifies the irradiation angle of the strobe device 300 by changing the relative position between the discharge tube 309 and optical system 316 based on the focal length information.

In step S312, the main controller 101 communicates with the strobe device 300 via the communication line SC to obtain strobe information from the strobe device 300. Note that the strobe information is stored in a memory of the strobe controller 301, and includes, for example, current emission mode information and charging information of the main capacitor 304.

In step S314, the main controller 101 determines whether or not to execute AF processing. Note that whether or not to execute the AF processing may be set in advance for each image capturing mode of the image capturing apparatus 100 or may be set by the user. If the AF processing is to be executed, the process advances to step S316. On the other hand, if the AF processing is skipped (that is, if the user manually sets a focus), the process advances to step S320.

In step S316, the main controller 101 detects a focus state of the lens 200 by, for example, a known phase difference detection method, in cooperation with the focus detector 107. Note that which of the plurality of focus detection points the lens 200 is focused is decided according to, for example, user's settings, the image capturing mode, and a known algorithm based on near-point priority. The main controller 101 calculates a driving amount of the focus adjustment lens required to focus the lens 200 based on the detection result of the focus detector 107.

In step S318, the main controller 101 communicates with the lens 200 via the communication line SC to output the driving amount of the focus adjustment lens to the lens 200. Note that the lens controller 201 controls the lens driver 203 to drive the focus adjustment lens to an in-focus position based on the driving amount of the focus adjustment lens.

In step S320, the main controller 101 performs photometry in cooperation with the detector 106. In this embodiment, as shown in FIG. 2, the image capturing region of the image sensor 102 is divided into the 12 regions, and photometry is done respectively on the regions a11 to a43 to calculate luminance values. In this embodiment, luminance values of the regions a11 to a43 calculated in step S320 are stored as EVb(i) (i=11 to 43) in the RAM of the main controller 101.

In step S322, the main controller 101 sets a gain of an image signal generated by the image sensor 102 according to, for example, a user's input, in cooperation with the gain setting unit 108. The main controller 101 communicates with the strobe device 300 via the communication line SC to output gain information associated with the set gain to the strobe device 300.

In step S324, the main controller 101 decides an exposure value EVs using a known algorithm based on the luminance values EVb(i) of the regions a11 to a43 calculated in step S320.

In step S326, the main controller 101 communicates with the strobe device 300 via the communication line SC to determine whether or an energy required for the discharge tube 309 to emit light has been accumulated on the main capacitor 304, that is, charging of the main capacitor 304 is complete. If charging of the main capacitor 304 is complete, the process advances to step S328. On the other hand, if charging of the main capacitor 304 is not complete yet, the process advances to step S330.

In step S328, the main controller 101 decides a shutter speed Tv and aperture value Av suited to image capturing by controlling the strobe device 300 (discharge tube 309) to emit light based on the luminance values calculated in step S320.

In step S330, the main controller 101 decides a shutter speed Tv and aperture value Av suited to image capturing using natural light based on the luminance values calculated in step S320.

In step S332, the main controller 101 communicates with the strobe device 300 via the communication line SC to output miscellaneous strobe-related information to the strobe device 300.

In step S334, the main controller 101 determines whether or not the user presses the shutter button to its full-stroke position. If the user does not presses the shutter button to its full-stroke position, the process returns to step S304 to repeat the aforementioned operation. On the other hand, if the user presses the shutter button to its full-stroke position, the process advances to step S336 to execute image capturing processing, thus ending the operation.

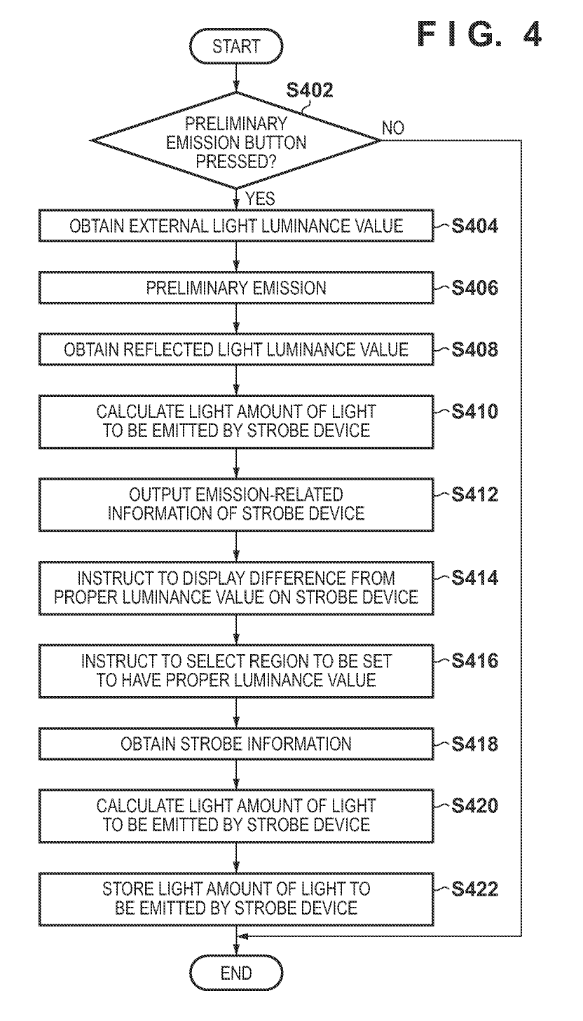

Next, an operation executed when the strobe device 300 performs preliminary emission, and an emission amount of the strobe device 300 at an actual image capturing timing is calculated from light reflected by an object (reflected light from the object) (to be referred to as “FEL” hereinafter) will be described below with reference to FIG. 4. Assume that the FEL processing is executed when the user presses the preliminary emission button on the operation unit 112 of the image capturing apparatus 100 in this embodiment. In this case, the shutter button is not pressed to its full-stroke position, needless to say.

In step S402, the main controller 101 determines whether or not the user presses the preliminary emission button. If the user does not press the preliminary emission button, the operation ends. On the other hand, if the user presses the preliminary emission button, the process advances to step S404.

In step S404, the main controller 101 performs photometry in cooperation with the detector 106 to obtain luminance values (external light luminance values) before preliminary emission by the strobe device 300. In this embodiment, external light luminance values of the regions a11 to a43 obtained by dividing the image capturing region of the image sensor 102 into the 12 regions, as shown in FIG. 2, are stored as EVa(i) (i=11 to 43) in the RAM of the main controller 101.

In step S406, the main controller 101 communicates with the strobe device 300 via the communication line SC to instruct the strobe device 300 to perform preliminary emission. The strobe controller 301 controls the trigger circuit 308 and emission controller 310 to control the discharge tube 309 to emit light based on the preliminary emission instruction from the image capturing apparatus 100, thereby irradiating an object with flat light of a predetermined light amount (that is, irradiating the object with preliminary light).

In step S408, the main controller 101 performs photometry in cooperation with the detector 106 to obtain luminance values (reflected light luminance values) at a preliminary emission timing. In this case, the reflected light luminance values are those of reflected light of the emitted preliminary light included in reflected light from the object when the preliminary emission is performed. More specifically, photometry is performed at the preliminary emission timing, and luminance values of the regions a11 to a43 obtained by dividing the image capturing region of the image sensor 102 into the 12 regions are stored as EVf(i) (i=11 to 43) in the RAM of the main controller 101. Differences are calculated by subtracting the expanded external light luminance values EVa from the luminance values EVf so as to extract reflected light luminance values EVdf(i) (i=11 to 43) of only reflected light of the emitted preliminary light, as given by:

EVdf(i)←LN2(2̂EVf(i)−2̂EVa(i)) (1)

The extracted reflected light luminance values are stored in the RAM of the main controller 101. Note that these reflected light luminance values EVdf(i) are corrected based on a guide number corresponding to a zoom position of the lens 200, the charging voltage of the main capacitor 304 of the strobe device 300, and the like.

In step S410, the main controller 101 calculates a light amount of light to be emitted by the strobe device 300, which is required to set luminance values of regions, which satisfy a predetermined condition, of the plurality of regions obtained by dividing the image capturing region of the image sensor 102 to be proper luminance values. In this embodiment, the main controller 101 executes the overall average photometry processing based on focus detection points (Focus.p), focal length (f), preliminary emission amount (Qpre), and the like. Then, the main controller 101 selects which of luminance values of the regions a11 to a43 obtained by dividing the image capturing region of the image sensor 102 into the 12 regions is used as a proper luminance value, according to, for example, a known algorithm. Note that the preliminary emission amount (Qpre) is corrected based on the guide number corresponding to the zoom position of the lens 200, the charging voltage of the main capacitor 304 of the strobe device 300, and the like, and is obtained from the strobe device 300. A region selected from the regions a11 to a43 obtained by dividing the image capturing region of the image sensor 102 into the 12 regions is stored as P (P=11 to 43) in the RAM of the main controller 101. Then, a relative ratio r of a proper emission amount at an actual image capturing timing with respect to an emission amount at a preliminary emission timing on the selected region P is calculated from an exposure value EVs, luminance value EVb(P), gain, and reflected light luminance value EVdf(P), as given by:

r←LN2(2̂EVs−2̂EVb(P))−EVdf(P) (2)

The reason why a difference obtained by subtracting the expanded external light luminance value EVb from the exposure value EVs is used in formula (2) is to control the exposure value at the emission timing of the strobe device 300 to be proper by adding light emitted by the strobe device 300 to external light.

In step S412, the main controller 101 communicates with the strobe device 300 via the communication line SC to output emission-related information of the strobe device 300 to the strobe device 300. The emission-related information of the strobe device 300 includes position information of the region selected from the plurality of regions obtained by dividing the image capturing region of the image sensor 102. Also, the emission-related information of the strobe device 300 includes differences EVdisp(i) between a proper luminance value EVpo(i) (zero if it is proper) on the selected region and luminance values EVex(i) (increments/decrements from a proper reference) on other regions, as given by:

EVdisp(i)←EVpo(i)−EVex(i) (3)

In step S414, the main controller 101 communicates with the strobe device 300 via the communication line SC to instruct the strobe device 300 to display differences between luminance values respectively on the plurality of regions obtained by dividing the image capturing region of the image sensor 102 and a proper luminance value. In this embodiment, based on information output in step S416, differences between luminance values respectively on the plurality of regions obtained by dividing the image capturing region of the image sensor 102 and a proper luminance value are displayed as the numbers of steps on the display unit 318 of the strobe device 300. Note that the differences between luminance values respectively on the plurality of regions obtained by dividing the image capturing region of the image sensor 102 and a proper luminance value correspond to information associated with differences between the emission amount calculated in step S410 and proper emission amounts respectively for the plurality of regions obtained by dividing the image capturing region of the image sensor 102. Thus, the user can judge, based on the numbers of steps of the differences, how many steps the proper emission amounts respectively for the plurality of regions obtained by dividing the image capturing region of the image sensor 102 are separated from the emission amount calculated in step S410.

In step S416, the main controller 101 communicates with the strobe device 300 via the communication line SC to instruct the strobe device 300 to select a region to be set to have a proper luminance value of the plurality of regions obtained by dividing the image capturing region of the image sensor 102. For example, the main controller 101 instructs the display unit 318 of the strobe device 300 to display a message which prompts the user to select a region to be set to have a proper luminance value.

In step S418, the main controller 101 communicates with the strobe device 300 via the communication line SC to obtain strobe information from the strobe device 300. In this case, the strobe information includes the region selected on the strobe device 300 and correction amount information.

In step S420, the main controller 101 calculates a light amount of light to be emitted by the strobe device 300. More specifically, the main controller 101 calculates, based on the strobe information obtained in step S418, a light amount (a proper emission amount) of light to be emitted by the strobe device 300, which is required to set the luminance value on the selected region of the plurality of regions obtained by dividing the image capturing region of the image sensor 102 to be a proper luminance value. That is, when the emission amount calculated in step S410 has a difference from a proper emission amount for the selected region, an image is captured under the condition that the difference is compensated for. For example, the light amount calculated in step S410 can be multiplied by a difference between a difference EVdisp(P′) between the proper luminance value on a region P′ selected in step S416 and a luminance value on another region, and the luminance value EVpo(P). Also, the light amount of light to be emitted by the strobe device 300 may be calculated by calculating a relative ratio r of a proper emission amount at an actual image capturing timing with respect to an emission amount at a preliminary emission timing on the selected region P, as given by:

r←LN2(2̂EVs−2̂EVb(P′))−EVdf(P′) (4)

In step S422, the main controller 101 stores the light amount calculated in step S420, that is, the light amount of light to be emitted by the strobe device 300 at an actual image capturing timing in its RAM, thus ending the operation.

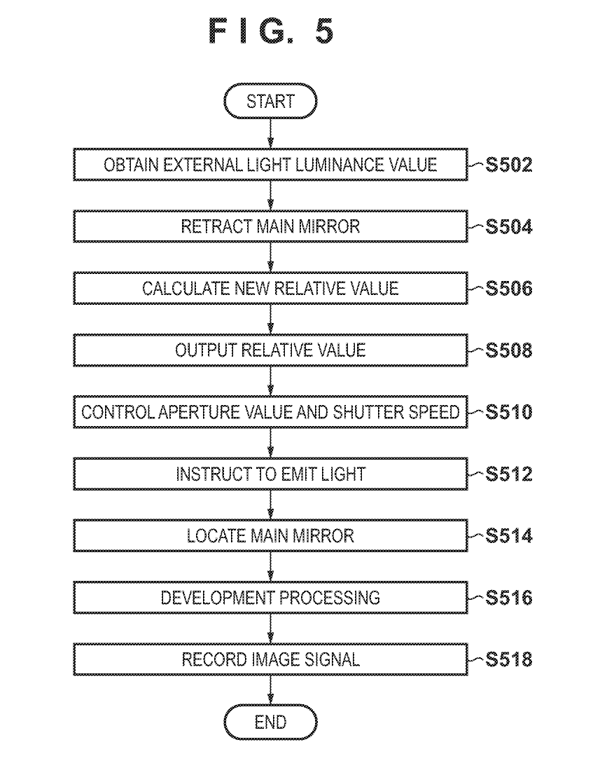

Next, an operation when the user presses the shutter button to its full-stroke position (that is, the image capturing processing in step S336) will be described below with reference to FIG. 5.

In step S502, the main controller 101 performs photometry in cooperation with the detector 106 to obtain luminance values (external light luminance values). In step S504, the main controller 101 retracts the main mirror 104 from an image capturing optical path. In step S506, the main controller 101 calculates a new relative ratio r by correcting the relative ratio r based on the shutter speed Tv, a preliminary emission time tpre, and a correction coefficient c set in advance by the user, as given by:

r←r+Tv−tpre+c (5)

The reason why the relative ratio r is corrected using the shutter speed Tv and emission time tpre in formula (5) is to normally compare a photometry integrated value INTp at a preliminary emission timing and a photometry integrated value INTm at an actual image capturing timing.

In step S508, the main controller 101 communicates with the strobe device 300 via the communication line SC to output the relative value r of the emission amount at the preliminary emission timing required to decide the emission amount at the actual image capturing timing to the strobe device 300.

In step S510, the main controller 101 communicates with the lens 200 via the communication line SC to instruct the lens 200 to set the stop 205 to have the aperture value Av based on the exposure value EVs. Also, the main controller 101 controls the shutter 103 to have the decided shutter speed Tv. In this manner, the aperture value of the stop 205 and the shutter speed of the shutter 103 are controlled (set) in step S510.

In step S512, the main controller 101 communicates with the strobe device 300 via the communication line SC to instruct the strobe device 300 to emit light in synchronism with the open/close timing of the shutter 103. Note that in the strobe device 300, light emitted by the discharge tube 309 is controlled based on the relative value r from the image capturing apparatus 100 to have a proper emission amount.

In step S514, the main controller 101 locates the main mirror 104 retracted from the image capturing optical path in the image capturing optical path. In step S516, the main controller 101 executes development processing in cooperation with the gain setting unit 108, image processor 111, and the like. More specifically, a pixel signal generated by the image sensor 102 is amplified by a gain set by the gain setting unit 108, and is converted into a digital image signal by the A/D converter 109. Then, the digital image signal undergoes predetermined image processing such as white balance processing in the image processor 111. In step S518, the main controller 101 records the image signal which has undergone the development processing in step S516 in a recording medium (not shown) such as a memory, thus ending the operation.

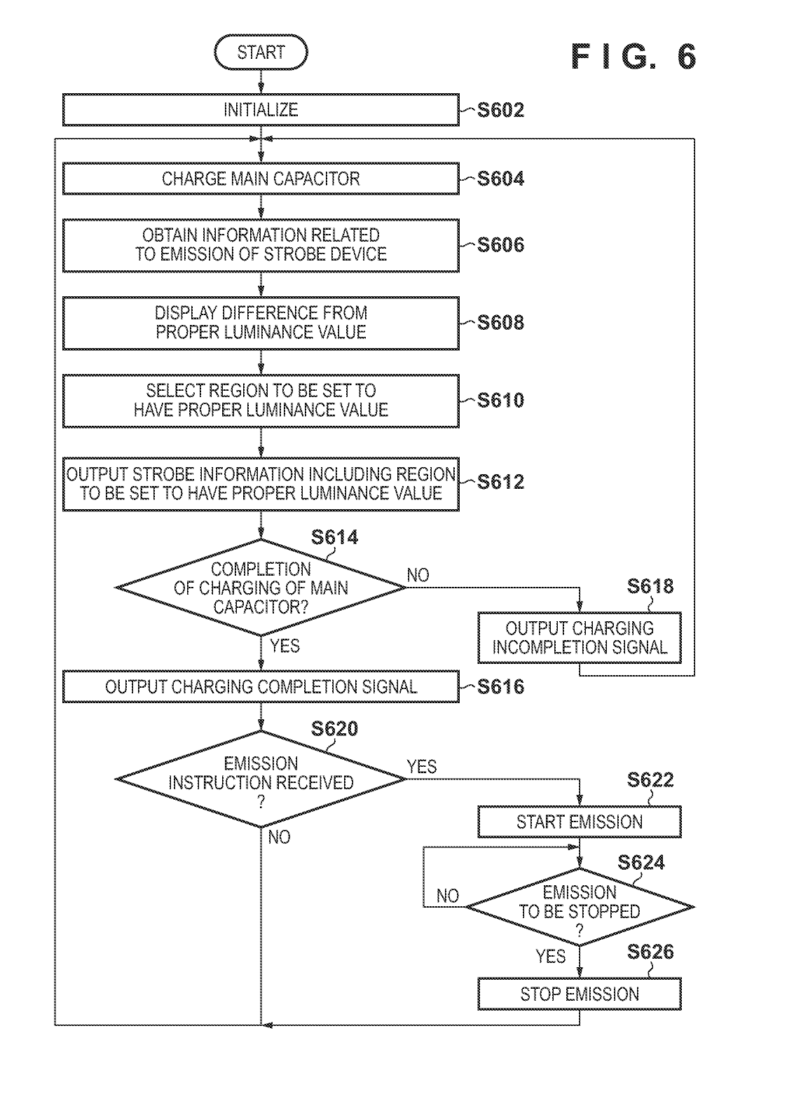

A practical operation of the strobe device 300 related to steps S414 and S416 will be described below with reference to FIG. 6. Note that the strobe device 300 starts its operation when a power switch of the strobe device 300 is turned on.

In step S602, the strobe controller 301 initializes its memories and ports. Also, the strobe controller 301 loads information input at the input unit 317, and sets an emission mode, emission amount, and the like. Note that when an output request of strobe information is received from the image capturing apparatus 100, the strobe controller 301 outputs the strobe information to the image capturing apparatus 100 via the communication line SC.

In step S604, the strobe controller 301 charges the main capacitor 304 by operating the booster circuit 303 (that is, it begins to charge the main capacitor 304).

In step S606, the strobe controller 301 communicates with the image capturing apparatus 100 via the communication line SC to obtain emission-related information of the strobe device 300 output from the image capturing apparatus 100 in step S412, and to store the obtained information in the RAM of itself. Note that when the emission-related information of the strobe device 300 has already been stored in the RAM, it is updated by the information obtained in step S606.

In step S608, the strobe controller 301 displays the strobe information including the differences between luminance values respectively on the plurality of regions obtained by dividing the image capturing region of the image sensor 102 and a proper luminance value on the display unit 318 based on the information obtained in step S606.

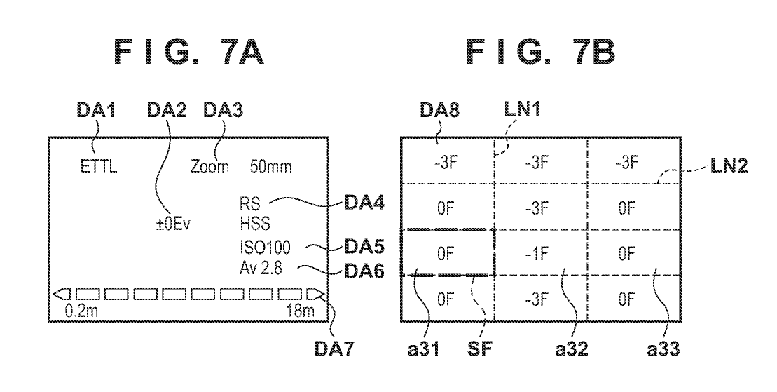

FIGS. 7A and 7B show display examples of the strobe information on the display unit 318 of the strobe device 300. FIG. 7A shows a display example of general strobe information. Referring to FIG. 7A, a display area DA1 displays an “M” mark indicating a manual emission mode or an “ETTL” mark indicating an automatic emission mode. A display area DA2 displays a light adjustment correction mark (for example, “±0 Ev”), and a display area DA3 displays focal length information (for example, “Zoom 50 mm”) of the lens 200. A display area DA4 displays rear-curtain synchro information or high-speed synchro information. A display area DA5 displays ISO speed information (gain). A display area DA6 displays aperture information of the lens 200. A display area DA7 displays a synchronizing distance range.

FIG. 7B shows a display example after execution of the FEL processing. Referring to FIG. 7B, reference numerals LN1 and LN2 denote dividing lines which divide a display screen of the display unit 318, and are displayed in correspondence with the regions a11 to a43 (see FIG. 2) obtained by dividing the image capturing region of the image sensor 102 into the 12 regions. Display areas DA8 of the 12 regions divided by the dividing lines LN1 and LN2 display differences between luminance values on the regions a11 to a43 obtained by dividing the image capturing region of the image sensor 102 into the 12 regions and a proper luminance value as the numbers of steps. For example, each display area DA8 displays “0F” if a luminance value is proper, or displays a difference from a proper luminance value (for example, “−3F”, “−1F”, or the like) if a luminance value is improper.

In step S610, the strobe controller 301 selects a region to be set to have a proper luminance value of the plurality of regions obtained by dividing the image capturing region of the image sensor 102 according to a user's input. In this embodiment, a selection frame SF used to select a region to be set to have a proper luminance value, is displayed, as shown in FIG. 7B, and the user shifts this selection frame SF to select the region to be set to have a proper luminance value. Note that the user can select an arbitrary region to be set to have a proper luminance value by operating the input unit 317. For example, every time the user presses a selection button included in the input unit 317 once, the selection frame SF can be shifted in turn like the region a11→region a12→region a13→region a21→ . . . →region a43.

In step S612, the strobe controller 301 communicates with the image capturing apparatus 100 via the communication line SC to output strobe information including the region to be set to have a proper luminance value, which is selected in step S610, to the image capturing apparatus 100.

In step S614, the strobe controller 301 determines whether or not the voltage boosted by the booster circuit 303 has reached a voltage level required for the discharge tube 309 to emit light, that is, charging of the main capacitor 304 is complete. If charging of the main capacitor 304 is complete, the process advances to step S616. On the other hand, if charging of the main capacitor 304 is not complete yet, the process advances to step S618.

In step S616, the strobe controller 301 communicates with the image capturing apparatus 100 via the communication line SC to output a charging completion signal indicating that charging of the main capacitor 304 is complete (that is, the discharge tube 309 is ready to emit light) to the image capturing apparatus 100.

In step S618, the strobe controller 301 communicates with the image capturing apparatus 100 via the communication line SC to output a charging incompletion signal indicating that charging of the main capacitor 304 is not complete yet (that is, the discharge tube 309 is not ready to emit light) to the image capturing apparatus 100. Also, the strobe controller 301 charges the main capacitor 304 by operating the booster circuit 303 (the process returns to step S604).

In step S620, the strobe controller 301 communicates with the image capturing apparatus 100 via the communication line SC to determine whether or not to receive an emission instruction of the strobe device 300 from the image capturing apparatus 100. If no emission instruction of the strobe device 300 is received, the process returns to step S604. On the other hand, if an emission instruction of the strobe device 300 is received, the process advances to step S622.

In step S622, the strobe controller 301 starts emission of the discharge tube 309 in cooperation with the emission controller 310. More specifically, the strobe controller 301 inputs a trigger signal to the emission controller 310 from an emission control terminal via the AND gate 314. The emission controller 310 controls the discharge tube 309 to start emission based on the trigger signal from the strobe controller 301.

In step S624, the strobe controller 301 determines whether or not the emission amount of the strobe device 300 (discharge tube 309) has reached the light amount of light to be emitted by the strobe device 300, that is, whether or not to stop emission of the strobe device 300. If emission of the strobe device 300 is not to be stopped, the strobe controller 301 repeats step S624. On the other hand, if emission of the strobe device 300 is to be stopped, the process advances to step S626. Note that the emission amount since the strobe device 300 has began to emit light can be calculated by the photodiode 311 and integrating circuit 312, as described above. The integrating circuit 312 integrates a light-receiving current of the photodiode 311, and inputs its output to the inverting input terminal of the comparator 313 and the D/A converter output terminal of the strobe controller 301. The non-inverting input terminal of the comparator 313 is connected to the D/A converter output terminal of the strobe controller 301, and a D/A converter value corresponding to the light amount of light to be emitted by the strobe device 300 is set.

In step S626, the strobe controller 301 stops emission of the discharge tube 309 in cooperation with the emission controller 310, and the process returns to step S604. More specifically, the strobe controller 301 inputs an emission stop signal to the emission controller 310 from the emission control terminal to via the AND gate 314. The emission controller 310 controls to stop emission of the discharge tube 309 based on the emission stop signal from the strobe controller 301.

In the image capturing system 1 of this embodiment, the strobe device 300 can display information associated with differences between luminance values respectively on the plurality of regions obtained by dividing the image capturing region of the image sensor 102 and a proper luminance value, that is, differences between the emission amount calculated in step S410 and proper emission amounts respectively for the plurality of regions obtained by dividing the image capturing region of the image sensor 102. Also, the strobe device 300 can select a region to be set to have a proper luminance value of the plurality of regions obtained by dividing the image capturing region of the image sensor 102. Therefore, the image capturing system 1 of this embodiment can set a proper exposure value at a point (region) intended by the user even in a composition including a plurality of objects.

### Second Embodiment

In the first embodiment, the strobe device 300 selects a region to be set to have a proper luminance value of the plurality of regions obtained by dividing the image capturing region of the image sensor 102. However, the image capturing apparatus 100 may select a region to be set to have a proper luminance value of the plurality of regions obtained by dividing the image capturing region of the image sensor 102.

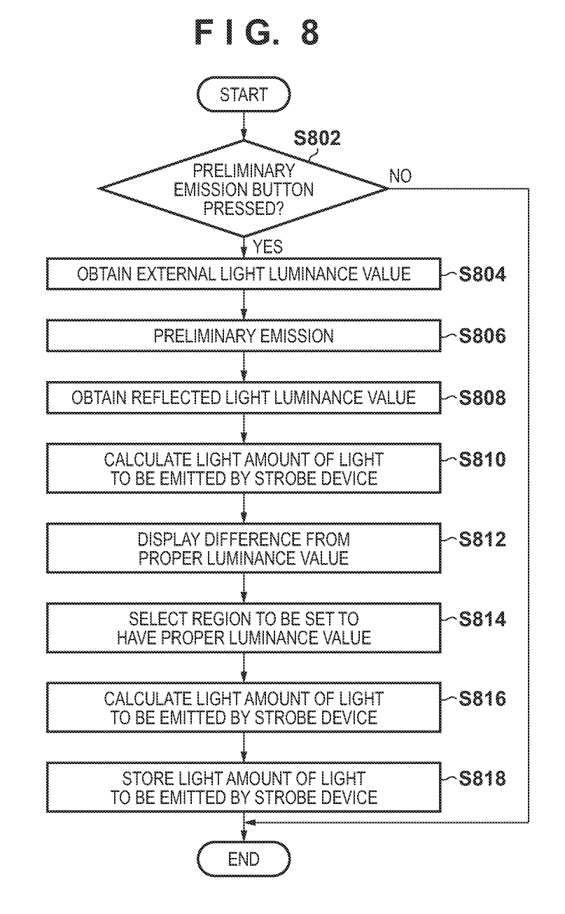

FIG. 8 is a flowchart for explaining the FEL operation when the image capturing apparatus 100 selects a region to be set to have a proper luminance value of the plurality of regions obtained by dividing the image capturing region of the image sensor 102.

Note that steps S802 to S810, S816, and S818 are the same as steps S402 to S410, S420, and S422, and a description thereof will not be repeated.

In step S812, the main controller 101 displays, on the display unit 113, differences between luminance values respectively on the plurality of regions obtained by dividing the image capturing region of the image sensor 102 and a proper luminance value. In this case, an image captured at a preliminary emission timing may be superimposed.

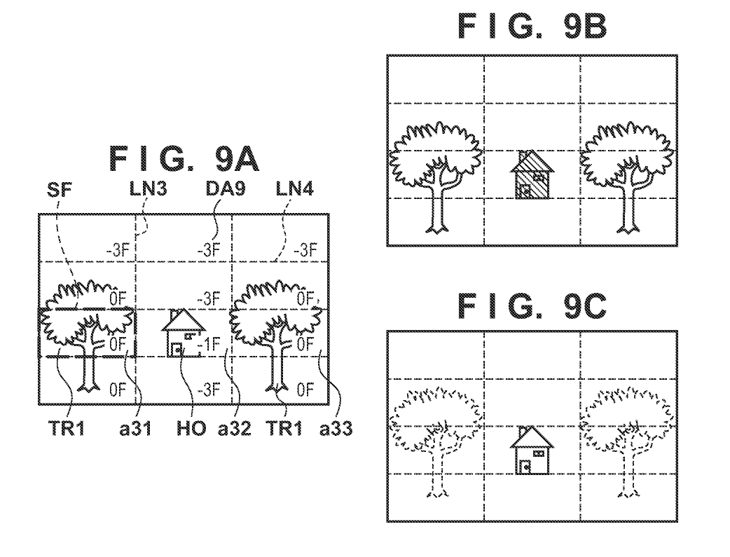

FIG. 9A shows a display example of strobe information on the display unit 113 of the image capturing apparatus 100. Referring to FIG. 9A, reference numerals LN3 and LN4 denote dividing lines which divide a display screen of the display unit 113, and are displayed in correspondence with the regions a11 to a43 (see FIG. 2) obtained by dividing the image capturing region of the image sensor 102 into 12 regions. Display areas DA9 of the 12 regions divided by the dividing lines LN3 and LN4 display differences between luminance values on the regions a11 to a43 obtained by dividing the image capturing region of the image sensor 102 into the 12 regions and a proper luminance value as the numbers of steps. For example, each display area DA9 displays “0F” if a luminance value is proper, or displays a difference from a proper luminance value (for example, “−3F”, “−1F”, or the like) if a luminance value is improper.

In step S814, the main controller 101 selects a region to be set to have a proper luminance value of the plurality of regions obtained by dividing the image capturing region of the image sensor 102 according to a user's input. In this embodiment, a selection frame SF used to select a region to be set to have a proper luminance value is displayed, as shown in FIG. 9A, and the user shifts this selection frame SF to select the region to be set to have a proper luminance value. Note that the user can select an arbitrary region to be set to have a proper luminance value by operating the operation unit 112. For example, every time the user presses a selection button included in the operation unit 112 once, the selection frame SF can be shifted in turn like the region a11→region a12→region a13→region a21→ . . . →region a43.

FIG. 9B shows an image captured when the region a31 is selected as a region to be set to have a proper luminance value from the regions a11 to a43 obtained by dividing the image capturing region of the image sensor 102 into the 12 regions. Since the region a31 is selected as a region to be set to have a proper luminance value, the regions a21, a41, a23, a33, and a43 also have a proper luminance value. Therefore, a tree TR1 which exists on the regions a21, a31, and a41, and a tree TR2 which exists on the regions a23, a33, and a43 have a proper exposure value. On the other hand, a house HO which exists on the region a32 has an underexposure value (−1F) compared to the proper exposure value.

FIG. 9C shows an image captured when the region a32 is selected as a region to be set to have a proper luminance value from the regions a11 to a43 obtained by dividing the image capturing region of the image sensor 102 into the 12 regions. In this case, the house HO which exists on the region a32 has a proper exposure value. On the other hand, the tree TR1 which exists on the regions a21, a31, and a41, and the tree TR2 which exists on the regions a23, a33, and a43 have an overexposure value (+1F) compared to the proper exposure value.

Note that in the operation of the strobe device 300 in this embodiment, steps S608 and S610 shown in the flowchart of FIG. 6 can be omitted. However, general strobe information shown in FIG. 7A can be displayed on the display unit 318 of the strobe device 300, needless to say.

In the image capturing system 1 of this embodiment, the image capturing apparatus 100 can display information associated with differences between luminance values respectively on the plurality of regions obtained by dividing the image capturing region of the image sensor 102 and a proper luminance value, that is, differences between an emission amount calculated in step S810 and proper emission amounts respectively for the plurality of regions obtained by dividing the image capturing region of the image sensor 102. Also, the image capturing apparatus 100 can select a region to be set to have a proper luminance value of the plurality of regions obtained by dividing the image capturing region of the image sensor 102. Therefore, the image capturing system 1 of this embodiment can set a proper exposure value at a point (region) intended by the user even in a composition including a plurality of objects.

### Third Embodiment

In the first embodiment, after the FEL processing, the strobe device 300 selects a region to be set to have a proper luminance value of the plurality of regions obtained by dividing the image capturing region of the image sensor 102. However, in the strobe device 300, the plurality of regions obtained by dividing the image capturing region of the image sensor 102 may be displayed on the display unit 318, and a region to be set to have a proper luminance value may be set (selected) in advance using the input unit 317, and the set region may be set to have the proper luminance value.

In this manner, in the strobe device 300, a region to be set to have a proper luminance value of the plurality of regions obtained by dividing the image capturing region of the image sensor 102 may be set in advance, and preliminary emission may be performed to calculate an emission amount of the strobe device 300 at an actual image capturing timing. The image capturing system 1 of this embodiment can also set a proper exposure value at a point (region) intended by the user even in a composition including a plurality of objects.

### Fourth Embodiment

In the second embodiment, after the FEL processing, the image capturing apparatus 100 selects a region to be set to have a proper luminance value of the plurality of regions obtained by dividing the image capturing region of the image sensor 102. However, in the image capturing apparatus 100, the plurality of regions obtained by dividing the image capturing region of the image sensor 102 may be displayed on the display unit 113, and a region to be set to have a proper luminance value may be set (selected) in advance using the operation unit 112, and the set region may be set to have the proper luminance value.

In this manner, in the image capturing apparatus 100, a region to be set to have a proper luminance value of the plurality of regions obtained by dividing the image capturing region of the image sensor 102 may be set in advance, and preliminary emission may be performed to calculate an emission amount of the storage device 300 at an actual image capturing timing. The image capturing system 1 of this embodiment can also set a proper exposure value at a point (region) intended by the user even in a composition including a plurality of objects.

### Fifth Embodiment

The first embodiment has been made under the assumption that an image of an object is captured immediately after the FEL operation. However, in some cases, an image of an object may be captured after a while in place of capturing the image immediately after the FEL operation. In such case, since a composition and environmental light (external light) may have changed, a proper exposure value may not be set at a point (region) intended by the user.

Hence, in this embodiment, photometry is made after a region to be set to have a proper luminance value is selected from the plurality of regions obtained by dividing the image capturing region of the image sensor, and whether or not to perform preliminary emission again is decided according to changes of luminance values respectively on the plurality of regions. When it is decided that preliminary emission is to be performed again, the preliminary emission is performed again to calculate an emission amount of the strobe device at an actual image capturing timing. That is, of reflected light rays from an object obtained when the preliminary emission is performed again, luminance values of reflected light rays of the emitted preliminary light are obtained. Then, a light amount of light to be emitted by the strobe device, which is required to set luminance values on the regions obtained by dividing the image capturing region of the image sensor to be proper luminance values, is calculated.

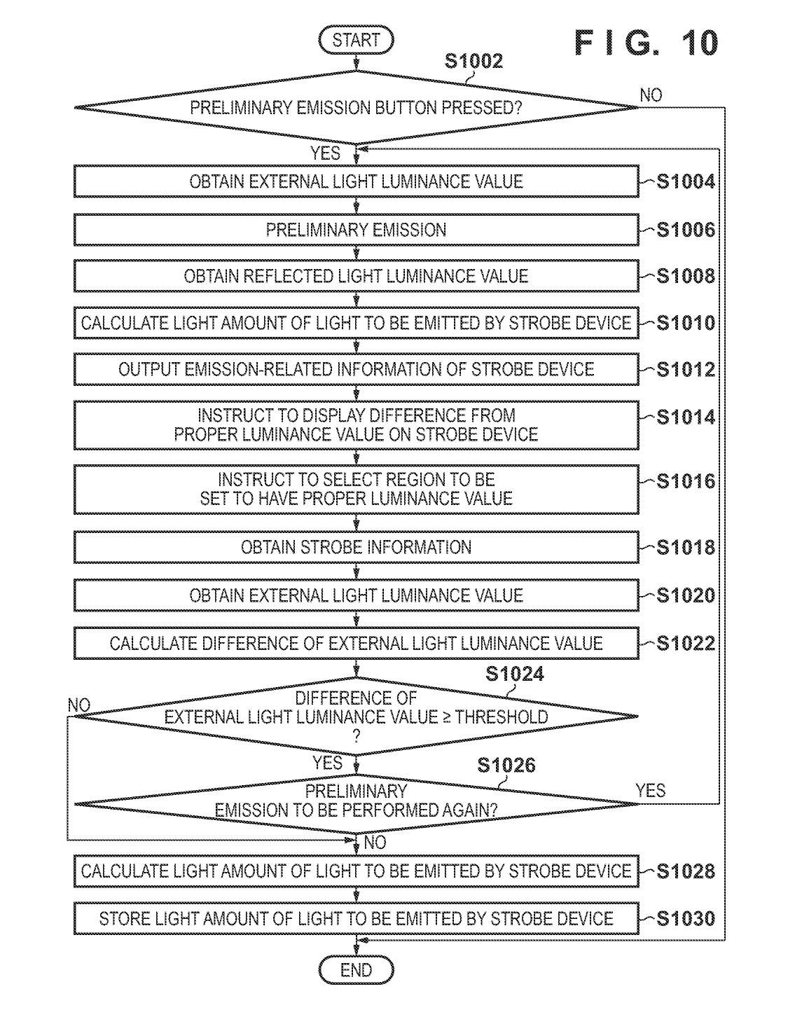

FIG. 10 is a flowchart for explaining the FEL operation in consideration of changes of a composition and environmental light (external light). Note that steps S1002 to S1018, S1028, and S1030 are the same as steps S402 to S422, and a description thereof will not be repeated.

In step S1020, the main controller 101 performs photometry in cooperation with the detector 106 as in step S1004 (S404) to obtain external light luminance values. In this embodiment, external light luminance values respectively on the regions a11 to a43 obtained by dividing the image capturing region of the image sensor 102 into 12 regions are stored as EVa2(i) (i=11 to 43) in the RAM of the main controller 101.

In step S1022, the main controller 101 calculates differences EVa3(i) between external light luminance values EVa(i) obtained in step S1004 and external light luminance values EVa2(i) obtained in step S1020, as given by:

EVa3(i)←EVa2(i)−EVa(i) (6)

In step S1024, the main controller 101 determines whether or not the differences EVa3(i) of the external light luminance values, which are calculated in step S1022, are equal to or larger than a threshold. If the differences EVa3(i) of the external light luminance values are not equal to or larger than the threshold, the main controller 101 determines that the composition and environmental light remain unchanged, and the process jumps to step S1028. On the other hand, if the differences EVa3(i) of the external light luminance values are equal to or larger than the threshold, the main controller 101 determines that the composition and environmental light have changed, and the process advances to step S1026.

In step S1026, the main controller 101 decides whether or not to perform preliminary emission again. Whether or not to perform preliminary emission again may be set for each image capturing mode of the image capturing apparatus 100 or each emission mode of the strobe device 300, or may be selected by the user at the operation unit 112 of the image capturing apparatus 100 or the input unit 317 of the strobe device 300 in each case. If it is decided that preliminary emission is to be performed again, the process returns to step S1004. Then, the main controller 101 performs preliminary emission again to calculate an emission amount of the strobe device at an actual image capturing timing (that is, it executes steps S1004 to S1018 again). On the other hand, if it is decided that preliminary emission is not to be performed again, the process advances to step S1028.

In the image capturing system 1 of this embodiment, the strobe device 300 can display information associated with differences between luminance values respectively on the plurality of regions obtained by dividing the image capturing region of the image sensor 102 and a proper luminance value, that is, differences between the emission amount calculated in step S1010 and proper emission amounts respectively for the plurality of regions obtained by dividing the image capturing region of the image sensor 102. Also, the strobe device 300 can select a region to be set to have a proper luminance value of the plurality of regions obtained by dividing the image capturing region of the image sensor 102. Furthermore, after the region to be set to have a proper luminance value is selected, photometry is performed, and when differences of luminance values are equal to or larger than the threshold, that is, when the luminance values have been changed by a predetermined value or more before and after the emission amount is calculated in step S1010, and it is considered that the composition and environmental light have changed, preliminary emission is performed again to calculate the emission amount of the strobe device at an actual image capturing timing. Therefore, the image capturing system 1 of this embodiment can set an proper exposure value at a point (region) intended by the user for a composition including a plurality of objects even when the composition and environmental light (external light) have changed.

### Sixth Embodiment

The second embodiment has been made under the assumption that an image of an object is captured immediately after the FEL operation. However, in some cases, an image of an object may be captured after a while in place of capturing the image immediately after the FEL operation. In such case, since a composition and environmental light (external light) may have changed, a proper exposure value may not be set at a point (region) intended by the user.

Hence, in this embodiment, after a region to be set to have a proper luminance value is selected from the plurality of regions obtained by dividing the image capturing region of the image sensor, photometry is performed, and whether or not to perform preliminary emission again is decided according to changes of luminance values respectively on the plurality of regions. When it is decided that preliminary emission is to be performed again, the preliminary emission is performed again to calculate an emission amount of the strobe device at an actual image capturing timing.

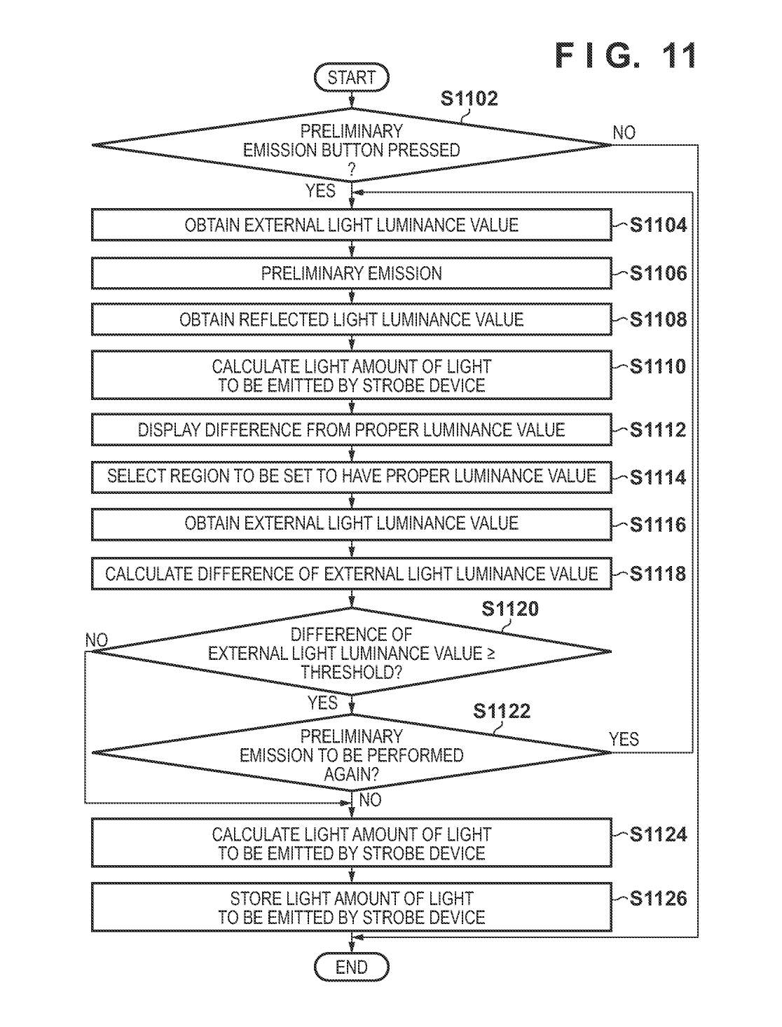

FIG. 11 is a flowchart for explaining the FEL operation in consideration of changes of a composition and environmental light (external light). Note that steps S1102 to S1114, S1124, and S1126 are the same as steps S802 to S818, and a description thereof will not be repeated.

In step S1116, the main controller 101 performs photometry in cooperation with the detector 106 as in step S1104 to obtain external light luminance values. In this embodiment, external light luminance values respectively on the regions a11 to a43 obtained by dividing the image capturing region of the image sensor 102 into 12 regions are stored as EVa2(i) (i=11 to 43) in the RAM of the main controller 101.

In step S1118, the main controller 101 calculates differences EVa3(i) between external light luminance values EVa(i) obtained in step S1104 and external light luminance values EVa2(i) obtained in step S1116, as given formula (6) above.

In step S1120, the main controller 101 determines whether or not the differences EVa3(i) of the external light luminance values, which are calculated in step S1118, are equal to or larger than a threshold. If the differences EVa3(i) of the external light luminance values are not equal to or larger than the threshold, the main controller 101 determines that the composition and environmental light remain unchanged, and the process jumps to step S1124. On the other hand, if the differences EVa3(i) of the external light luminance values are equal to or larger than the threshold, the main controller 101 determines that the composition and environmental light have changed, and the process advances to step S1122.

In step S1122, the main controller 101 decides whether or not to perform preliminary emission again. Whether or not to perform preliminary emission again may be set for each image capturing mode of the image capturing apparatus 100 or each emission mode of the strobe device 300, or may be selected by the user at the operation unit 112 of the image capturing apparatus 100 or the input unit 317 of the strobe device 300 in each case. If it is decided that preliminary emission is to be performed again, the process returns to step S1104. Then, the main controller 101 performs preliminary emission again to calculate an emission amount of the strobe device at an actual image capturing timing (that is, it executes steps S1104 to S1114 again). On the other hand, if it is decided that preliminary emission is not to be performed again, the process advances to step S1124.

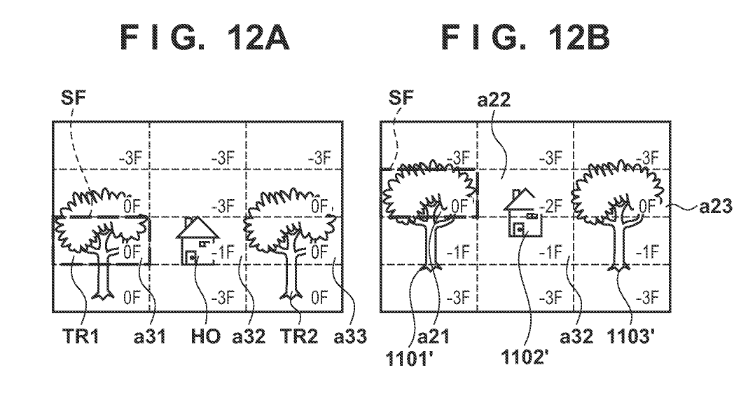

The FEL operation when a composition has changed will be practically described below with reference to FIGS. 12A and 12B. FIG. 12A shows a composition in which a tree TR1 exists on the region a31, a tree TR2 exists on the region a33, and a house HO exists on the region a32, as in FIG. 9A. Since the region a31 where a selection frame SF is located is selected as a region to be set to have a proper luminance value, luminance values of the regions a31 and a33 are proper, and “0F” is displayed. On the other hand, a luminance value of the region a32 is improper, and “−1F” is displayed. FIG. 12B shows a composition in which a tree TR1 exists on the region a21, a tree TR2 exists on the region a23, and a house HO exists on the regions a22 and a32.

A case will be examined below wherein the composition shown in FIG. 12A has changed to that shown in FIG. 12B. In this case, when an image of an object is captured without performing another preliminary emission to calculate an emission amount of the strobe device at an actual image capturing timing, the tree TR1 which exists at a point (the region a31 in the composition shown in FIG. 12A) intended by the user may not be properly exposed. Hence, when the composition has changed, preliminary emission is performed again, and the region a21 where the tree TR2 exists has to be selected as a region to be set to have a proper luminance value to calculate an emission amount of the strobe device at an actual image capturing timing, as shown in FIG. 12B. FIG. 12B shows a result obtained when the preliminary emission is performed again, and the region a21 is selected as a region to be set to have a proper luminance value, so as to calculate an emission amount of the strobe device at an actual image capturing timing. The region a21 has a proper luminance value, and “0F” is displayed.

In the image capturing system 1 of this embodiment, the strobe device 300 can display differences between luminance values respectively on the plurality of regions obtained by dividing the image capturing region of the image sensor 102, and a proper luminance value. Also, the strobe device 300 can select a region to be set to have a proper luminance value of the plurality of regions obtained by dividing the image capturing region of the image sensor 102. Furthermore, after the region to be set to have a proper luminance value is selected, photometry is performed, and when differences of luminance values are equal to or larger than the threshold, that is, when it is considered that the composition and environmental light have changed, preliminary emission can be performed again to calculate an emission amount of the strobe device at an actual image capturing timing. Therefore, the image capturing system 1 of this embodiment can set a proper exposure value at a point (region) intended by the user for a composition including a plurality of objects even when the composition and environmental light (external light) have changed.

### Seventh Embodiment

In the first to sixth embodiments, one region is selected (or set) as a region to be set to have a proper luminance value from the plurality of regions obtained by dividing the image capturing region of the image sensor. Alternatively, two or more regions may be selected (or set).

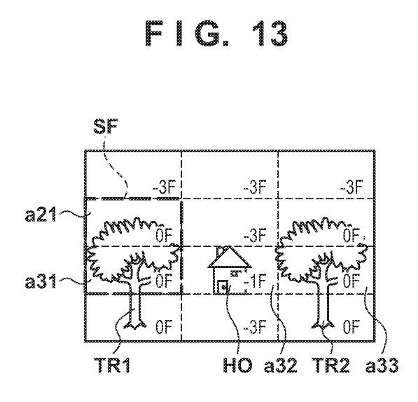

For example, as shown in FIG. 13, the regions a21 and a31 can also be selected as regions to be set to have a proper luminance value (that is, a selection frame SF can be located on the regions a21 and a31). In this case, as differences between the luminance values on the regions a21 and a31 and a proper luminance value, an intermediate value between a difference on the region a21 from the proper luminance value and that on the region a31 from the proper luminance value is displayed. Note that since the difference on the region a21 from the proper luminance value is “0F”, and that on the region a31 from the proper luminance value is “0F” in FIG. 13, “0F” is displayed as the intermediate value. Also, when three or more regions are selected as regions to be set to have a proper luminance value from the plurality of regions obtained by dividing the image capturing region of the image sensor, an average value of differences from a proper luminance value on these three or more regions can be displayed.

When two or more regions are selected as regions to be set to have a proper luminance value from the plurality of regions obtained by dividing the image capturing region of the image sensor, a light amount of light to be emitted by the strobe device, which is required to set an average light amount obtained by averaging light amounts on the two or more regions to be a proper light amount, is calculated.

In the image capturing system 1 of this embodiment, two or more regions can be selected (or set) as regions to be set to have a proper luminance value from the plurality of regions obtained by dividing the image capturing region of the image sensor. Hence, the image capturing system 1 of this embodiment can set a proper exposure value at points (regions) intended by the user even when an object exists across a plurality of regions.

Note that in the seven embodiments described above, when the display unit 113 displays an image corresponding to an image signal output from the image processor 111, in response to selection of a region to be set to have a proper luminance value, an image in which the selected region has a proper brightness may be displayed on the display unit 113.

When a proper emission amount for the selected region exceeds a possible emission amount, a difference between the emission amount calculated in, for example, step S410 and the proper emission amount for the selected region may be compensated for by a gain of an image signal.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

Also, the present invention may be applied to an image capturing system in which a strobe device is built in an image capturing apparatus, an image capturing system in which a lens is built in an image capturing apparatus, or an image capturing system in which an image capturing apparatus does not have any main mirror and pentagonal prism.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2010-225167 filed on Oct. 4, 2010, which is hereby incorporated by reference herein in its entirety.

What is claimed is:

1. An image capturing apparatus, which is configured to capture an image using a light-emitting device, comprising:
a photometry unit configured to perform photometry on a plurality of regions;
a calculation unit configured to calculate an emission amount of the light-emitting device based on photometry results of the photometry unit; and
a display unit configured to display information associated with differences between proper emission amounts respectively for the plurality of regions and the emission amount calculated by the calculation unit.

2. The apparatus according to claim 1, wherein when values based on photometry results obtained by performing photometry by the photometry unit without causing the light-emitting device to emit light have changed by not less than a predetermined value before and after the emission amount of the light-emitting device is calculated, the calculation unit re-calculates the emission amount of the light-emitting device.

3. The apparatus according to claim 1, further comprising:
an operation unit configured to accept an operation required to select an arbitrary region from the plurality of regions; and
a control unit configured to control, when a proper emission amount for the region selected by the operation accepted by the operation unit has a difference from the emission amount calculated by the calculation unit, to capture an image using the light-emitting device under a condition that the difference is compensated for.

4. The apparatus according to claim 1, wherein the calculation unit calculates a proper emission amount for a region which satisfies a predetermined condition of the plurality of regions.

5. The apparatus according to claim 1, wherein the calculation unit calculates the emission amount of the light-emitting device based on differences between values based on photometry results obtained by performing photometry by the photometry unit without causing the light-emitting device to emit light, and values based on photometry results obtained by performing photometry by the photometry unit by causing the light-emitting device to emit light.

6. The apparatus according to claim 3, wherein when not less than two regions are selected by the operation accepted by the operation unit, and when an average value of proper emission amounts for the selected regions has a difference from the emission amount calculated by the calculation unit, the control unit controls to capture an image using the light-emitting device under a condition that the difference is compensated for.

7. The apparatus according to claim 1, further comprising:
an operation unit configured to accept an operation required to select an arbitrary region from the plurality of regions,
wherein the display unit displays an image in which the region selected by the operation accepted by the operation unit has a proper brightness.

8. A light-emitting device, which is configured to be attached to an image capturing apparatus having a photometry unit configured to perform photometry on a plurality of regions, and a calculation unit configured to calculate an emission amount of the light-emitting device based on photometry results of the photometry unit, said device comprising:
a display unit configured to display information associated with differences between proper emission amounts respectively for the plurality of regions and the emission amount calculated by the calculation unit.

9. An image capturing system including an image capturing apparatus and a light-emitting device, comprising:
a photometry unit configured to perform photometry on a plurality of regions;
a calculation unit configured to calculate an emission amount of the light-emitting device based on photometry results of the photometry unit; and
a display unit configured to display information associated with differences between proper emission amounts respectively for the plurality of regions and the emission amount calculated by the calculation unit.
